(19) United States
(12) Patent Application Publication
(10) Pub. No.: US 2007/0176790 A1
(43) Pub. Date: Aug. 2, 2007

(54) Patient network with wireless medical apparatuses and allocation thereof to a patient and his network

(75) Inventors: Karin Klabunde, Bochum (DE); Heribert Baldus, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS NV, Eindhoven (NL)

(21) Appl. No.: 10/596,560

(22) PCT Filed: Dec. 13, 2004
(86) PCT No.: PCT/IB04/52772

§ 371 Date: Jun. 16, 2006

(30) Foreign Application Priority Data
Dec. 19, 2003 (EP) 03104839.0

(51) Int. Cl. H04Q 9/00

(52) U.S. Cl. 340/870.07

(57) ABSTRACT

Wireless medical apparatus (3) having a transceiver unit (23), an indicating device (27) and an input device (25) and having a function for automatic integration of the medical apparatus (3) into the nearest patient network (13) Allocation of the medical apparatus (3) can be effected by a method in which the apparatus is integrated into the nearest patient network after enabling of the apparatus The patient network can be in the form of a personal area network

The invention relates to a patient network. The patient network is associated unambiguously with one patient. New apparatuses are to be integrated into the patient network.

U.S. Pat. No. 6,544,173 B2 discloses a patient monitoring system for recording vital signs data of a patient. The patient monitoring system comprises a patient monitor, a transceiver unit, which is connected by way of a data transfer structure to the central station. Patient data is fed from the patient monitor by way of a wireless connection to the transceiver unit. The vital signs data fed to the transceiver unit is forwarded to the central station. The patient monitoring system includes a database system, in which a series of information relating to each patient is stored. For an allocation of incoming data by a patient monitor, a list of the patients being recorded is displayed on the monitor. By selecting a patient, assignment of a patient to a monitor is effected.

It is an object of the present invention to provide a method for simplified allocation of wireless medical apparatuses to a patient and hence to simplify the integration of wireless medical apparatuses into a patient monitoring system.

It was a further object of the invention to provide a wireless medical apparatus, which permits simplified allocation to a patient and into a patient network.

The object of the invention is achieved by claims 1, 7 and 11.

By the procedure of providing the new method for integration of wireless medical apparatuses into a patient network, convenient integration of medical apparatuses into a patient network is possible. In the case of the method, a new medical apparatus that is to be allocated to a patient network is brought into close proximity with the patient. For example, the doctor enters the room with a new apparatus. Preferably the apparatus is already in an appropriate state “search for patient network”, or is put into this state by the doctor. The current local position of this medical apparatus is detected by a locating system. The locating system determines the patient network nearest to the medical apparatus and the locating system communicates the nearest patient network to the medical apparatus. After enabling, the medical apparatus is automatically integrated into the patient network.

At the central station, or rather in the apparatus that contains a representation, the representation of this patient network is updated accordingly. For example, after successful integration, the new apparatus sends appropriate information to the central station or to the corresponding apparatus in which a representation is filed. The representation here contains information about which apparatuses are integrated in the patient network.

In one embodiment, an input from clinic personnel is required for enabling. It can thus be ensured that the medical apparatus is integrated only into the patient network for which it is intended. There can be a provision that a confirmation is required, whereby the name of the patient to whom the medical apparatus is to be allocated must be confirmed. Confirmation of the patient can be carried out quickly and easily. There can be a provision that if there is no acknowledgement by the nearest patient network, an extended selection of patient networks located in the vicinity is offered for enabling. This selection can be limited to a predetermined number or to a predetermined spatial boundary.

In another embodiment, automated enabling according to logic criteria is provided. Provision can be made for this automated enabling to be deactivated according to logic criteria. The previously described automated integration can then be provided or alternatively a switch can be made to manual input.

In one embodiment, provision is made for the information relating to which apparatuses are already integrated in the patient network to be sent to the medical apparatus from the central system or from the apparatus that contains the representation of the patient network.

The feature of providing a wireless medical apparatus with a transceiver unit and with a function for automatic integration of the medical apparatus into a patient network enables the medical apparatus to be integrated into a patient network in a convenient manner. Information can be exchanged wirelessly through the transceiver unit and communication with other apparatuses can be established. A logical interconnection of several wireless medical apparatuses to form a patient network can be effected.

In one embodiment an input device is provided for manual enabling, which will normally be effected by clinic personnel.

Through the provision of an indicating device, the network into which the apparatus is or is to be integrated can be displayed.

In one embodiment, provision is made for the wireless medical apparatus to be equipped with a transceiver unit, which permits communication in different networks. Through the provision of a transceiver unit that permits communication with networks that have different ranges, it is possible to communicate with a wide variety of networks. Thus, the range provided for a patient network can be small. To detect locations of the medical apparatuses, a network having a larger range can be provided.

Furthermore, the transceiver unit of the apparatus is able to support the possibility of ad hoc peer-to-peer communication, that is, direction communication between the individual apparatuses, or communication from apparatus to apparatus by way of an infrastructure, that is, one apparatus talks via an access point of a WLAN and-via the underlying infrastructure to another apparatus.

In one embodiment, the medical apparatus is provided with a display as indicating device and with a search function. By means of the search function, medical apparatuses of a specific type or a specific medical apparatus can be shown on the display.

The locating system is used for use in a hospital, having a network and a memory in which location data of apparatuses situated within a monitoring range is stored. The monitoring range is restricted to the coverage of the network. The location data represents a unique identification of the location site.

In one embodiment, provision is made for information about an affiliation of the apparatuses to a logical patient network also to be stored in the memory.

Patient networks can be infrastructure-based. Infrastructure-based means that the communication between the apparatuses is effected not directly, but via an infrastructure, for example, via a wireless infrastructure: an apparatus talks to an access point. From there, data passes either directly via the access point to another apparatus or is first passed on to a different access point. The access points can be in either wired or wireless connection with one another. Typically, they are integrated into the wired infrastructure and provide wireless apparatuses with access to the information in the overall network. The wireless apparatuses can likewise be addressed from the overall network.

Alternatively, provision can be made for the apparatuses within a patient network to be in connection with one another by means of short-range ad hoc communication, for example, Bluetooth, and for just one of the apparatuses to be in direct connection with the hospital infrastructure, for example, via WLAN. In that case, a lower energy input is required for the short-range communication. Thus, provision can be made in particular for communication with the hospital infrastructure to be effected by way of an apparatus that has a relatively large energy store or is even connected up to the mains supply.

These and other aspects of the invention are apparent from and will be elucidated, by way of non-limitative example, with reference to the embodiment(s) described hereinafter.

In the drawings:

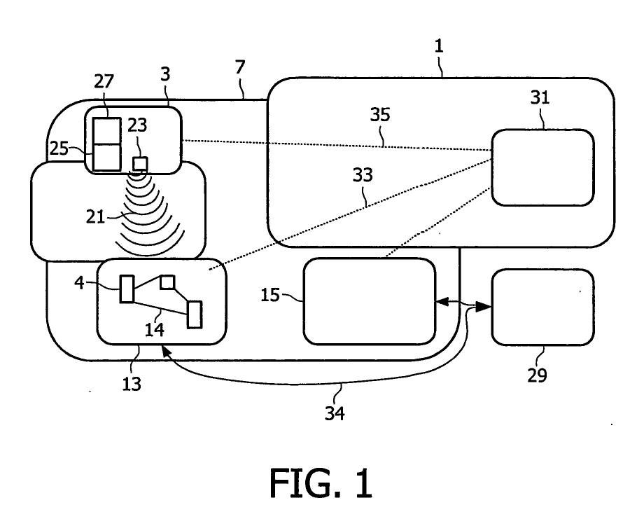

FIG. 1 shows schematically a patient monitoring system;

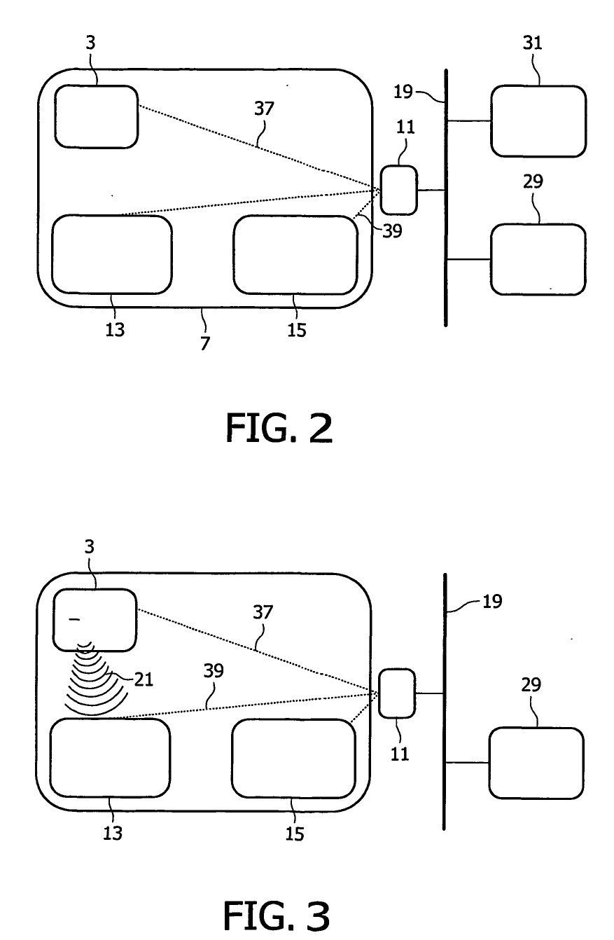

FIG. 2 shows the structure of a patient monitoring system with locating system;

FIG. 3 shows the structure of a patient monitoring system with environment detection.

First of all, the elementary structure of a patient monitoring system 1 will be described with reference to FIG. 1. The patient monitoring system 1 comprises a first patient network 13 and a further patient network 15. These two patient networks 13, 15 are arranged in a room 7 for patients. The patient networks 13, 15 are connected to an information center 29 via a signal connection 34.

In a first version, provision is made for the two patient networks 13, 15 to be in signal communication with an associated locating system 31 by way of a signal connection 33, see also FIG. 2. In another embodiment, provision is made for the apparatuses to ascertain their position relative to one another by way of relative environment detection, see also FIG. 3. These two versions are illustrated schematically in FIG. 1.

Each of these patient networks 13, 15 is allocated uniquely to one patient. One medical apparatus can be integrated in a patient network 13, 15 or alternatively several medical apparatuses 4 can be integrated. Generally, there will be several medical apparatuses around the patients. The medical apparatuses 4 can communicate with one another directly, preferably by way of a wireless signal connection 14, or, as shown in FIG. 2, can be in communication by way of a hospital infrastructure.

A patient network 13, 15 is created by allocating the apparatuses to a patient. A logical representation of the patient network 13, 15 exists on one of the apparatuses or in the information center 29. The representation allows easy access to the collected data and to the patient network 13, 15.

A patient monitor 3, as new apparatus, is to be integrated here into an existing patient network 13. The new apparatus is in communication via a signal connection 35 with the locating system 31. The locating system 31 can be arranged centrally or in the patient's room 7.

The new apparatus 3 has an indicating device 27, for example a display, and an input device 25. Furthermore, the new apparatus 3 has a transceiver unit 23. A sensor field 21 is generated by this transceiver unit 23.

In the following, two alternative system architectures are presented for a method for automatic allocation of a new medical apparatus 3, here a patient monitor, to an existing patient network 13. The first case represents the allocation procedure based on a system with a locating system 31 that supplies the absolute positions for the individual apparatuses and patient networks 13, 15.

The second case describes the allocation procedure based on environment detection by a sensor field 21. For example, field strength measurements can be used to determine relative distances between the apparatuses concerned. By measuring the field strength in the new apparatus, conclusions can be drawn about other apparatuses in the vicinity.

A version of the first system architecture with a locating system 31 is described with reference to FIG. 2. The patient network 13 comprises several apparatuses 4 in wireless communication, for example, ECG sensor, monitor, ventilator, infusion pump. These apparatuses are logically interconnected and form a patient network. At least one of these apparatuses of the patient network 13 is connected by way of a signal connection 39 and the data transfer structure 19 to a locating system 31. The data transfer structure 19 is used for patient monitoring. This data transfer structure 19 can be a network that is permanently installed in the hospital and comprises several transceiver units 11. Depending on the network technology used, the spacings of the transceiver units 11 are to be selected to provide complete coverage.

Each patient network 13, 15 is uniquely identified by means of a patient identification. There is a logical representation of the patient network 13, 15 that contains information about the apparatuses allocated to the patient network 13, 15 and about the patient. This representation is to be found centrally in the information center 29.

The data that is being collected from the different apparatuses of the patient network 13, 15 is sent to the information center 29. The information center 29 is a nerve center for monitoring and evaluating the vital signs parameters of the patients. The locating system 31 continuously determines the position of all wireless apparatuses and hence also of the apparatuses 3 that are not currently allocated to a patient network 13, 15. The apparatuses 3 that are not currently allocated to a patient network 13, 15 are in signal communication with the locating system 31 by way of a signal connection 37 and the data transfer structure 19.

A request can be directed to the locating system 31 to ask for the whereabouts of specific apparatuses. This request can be made from any desired apparatus, which can also be integrated in a patient network and is in signal communication with the locating system, or alternatively from the information center 29. Alternatively, arrangements can be made for the clinic personnel to be provided with separate pocket-format devices that are intended for implementing such search requests and are able to establish a signal connection with the locating system 31.

If the search request is performed from a medical apparatus, then the request can be made by means of the input device 25. The indicating device 27 can be used to display the search result. Preferably, the entered request is also shown on the indicating device 27, such as a display, so that monitoring of the entered request is possible.

On receiving the request, the whereabouts of the apparatus sought is supplied. In this connection, a search request can be made for a specific type of apparatus. Provision can be made for merely a predetermined number, such as for example 3 or 5, of the nearest apparatuses that are not currently integrated in a patient network to be displayed in response to such a request. Alternatively, a search request can be entered to display also those apparatuses that are integrated. Furthermore, a search request relating to the whereabouts of an individual apparatus is also possible.

For allocation of a new medical apparatus 3 to a patient network 13, knowledge about the local locating of the patient network 13 and of the medical apparatus 3 is used. In this connection, the knowledge can be absolute location knowledge, e.g. patient network 13 is located on the left in the patient's room 7. Signals characterizing the location of the patient network are fed by way of the signal connection 39 to a locating system 31, which determines there from the current local position and stores this. The new medical apparatus 3 as well is in communication by way of the signal connection 37, 19 with the locating system 31. If the locating system 31 detects the medical apparatus 3 in a location in the vicinity of the patient network 13, then the new medical apparatus 3 is informed that the patient network 13 is located in the vicinity. For integration of the apparatus 3 into this patient network 13, enabling is expected. Normally, enabling will be effected by clinic personnel, who will confirm through an input via the input device 25 that this apparatus is to be integrated into the identified patient network 13. Preferably, the indicating device will provide a visual or acoustic indication.

The input device 25 can be integrated in the medical apparatus 3 or can be a separate device carried with the clinic personnel, this separate device being in signal communication with the locating system 31 and preferably also having an indicating device 27. After enabling, the medical apparatus is automatically integrated into the patient network 13. Other than the enabling command for integration of the medical apparatus into a patient network, no further input by clinic personnel is required.

From the patient network, the data, that is, the vital signs data of the patient, is generally transferred to the central information center 29.

The following text describes the second system architecture with environment detection, in which no central locating system 31 is required, as is illustrated in FIG. 3.

The patient networks 13, 15 comprise one or more wireless medical apparatuses. Apparatuses such as, for example, ECG sensors, monitors, ventilators, infusion pumps, to name but a few, can be provided as wireless apparatuses 4. By logical interconnection, these apparatuses, which are allocated to the same patient, form a patient network 13, 15.

At least one of the apparatuses of the patient network has a connection to the hospital communications infrastructure 19, also referred to as the data transfer structure. This connection to the hospital communications infrastructure 19 is preferably wireless. The communications infrastructure 19 is used in patient monitoring. The various patient networks 13, 15 are in that case each uniquely identified by way of a patient identification. A logical representation of the patient network 13, 15 exists, containing information about the allocated apparatuses and the patient. This representation can be found on one of the apparatuses 4 concerned or centrally in the information center 29.

The representation of a patient network contains a unique patient identification, identification of the apparatuses allocated to the patient and information about the whereabouts of the patient network. The information about the whereabouts is either regularly updated or ascertained as needed.

Provision can also be made for the representation of the patient network to be stored on one of the apparatuses in the patient network and to be made available to the information center 29 when the information center 29 requests this information.

The data that is collected by the different apparatuses of the patient network 13, 15 is sent to the information center 29. The information center 29 is a nerve center for monitoring and evaluating the vital parameters of the patient. A new apparatus 3, which is to be integrated into the network, for example, an ECG patient monitor, has a transmitter and/or receiver, which monitors an environment area by means of a sensor field 21. A patient network 13 overlapping with the environment area 21 is detected by the new medical apparatus 3. The new medical apparatus 3 has an ad hoc connectivity interface, such as Bluetooth or WLAN ad hoc, for example. These short-range systems of a communication network are used to detect the apparatuses located close by. After enabling has been effected, the new medical apparatus 3 is integrated into the detected patient network.

The new method for integrating the new medical apparatus 3 will be described in detail in an everyday hospital situation.

A doctor or member of the nursing staff enters the patient's room 7 with the new apparatus 3. The apparatus 3 enquires which is the patient network nearest to him. The apparatus 3 discovers the nearest patient network 13. The apparatus 3 then awaits enabling. A patient monitor displays the name of the patient who is assigned to the detected nearest patient network 13. At other medical apparatuses, the name of the patient is displayed by the indicating device 27. Enabling can be effected by clinic personnel by operating keys on the monitor or the input device 25. Normally, this will also be possible without problems, since the apparatus is generally brought to the patient by clinic personnel.

Provision can be made for an environment area covering a radius of a minimum of 3 meters to a maximum of 10 meters around the apparatus to be detected. If a patient network is detected in this environment area 21 over a predetermined minimum time period, the apparatus is automatically integrated into this patient network 13. The minimum time period prevents the new apparatus from being integrated into different networks or from waiting for enabling during transport.

Integration can be triggered either from the existing patient network 13, or by a “connection request” of the medical apparatus 3. If several patient networks are detected, clinic personnel are offered a choice. Provision can also be made for the nearest detected patient network at any one time to be pre-selected and if there is no further input, apart from, if applicable, an enabling, the new apparatus 3 is then automatically integrated into this patient network 13.

After successful incorporation of the new medical apparatus 3 into the patient network 13, a report is sent to the information center 29. The administration listing of the patient in question, or rather the representation of the patient network 13, is appropriately updated.

On admission to hospital, patients can be provided with a small portable locatable unit, which already establishes a patient network 13, 15. These devices can be in the form of a wristwatch. By installing a patient network 13, 15 associated with the patient as early as his admission to hospital, the above-described method can be used for automatic allocation of medical apparatuses from the outset. Through a request to the location system, the patient can be located at any time by searching the corresponding patient network.

1. A method for integration of a medical wireless apparatus into a patient network, comprising the following steps:
bringing the medical apparatus into a vicinity of the patient network to which the medical apparatus is to be allocated,
detecting a current local position of the medical apparatus,
determining the patient network closest to the medical apparatus and communicating the closest patient network to the medical apparatus,
after enabling, integrating the medical apparatus into the patient network.

2. The method as claimed in claim 1, wherein a locating system is provided, which determines the current local position of the medical apparatus and the closest patient network and informs the medical apparatus of the closest patient network.

3. The method as claimed in claim 1, wherein the current local position of the medical apparatus and the closest patient network is determined by environment detection.

4. The method as claimed in claim 1, wherein for enabling an input by clinic personnel is required for enabling integration of the medical apparatus into the patient network.

5. The method as claimed in claim 1, wherein a predetermined logic criteria provides for automatic enablement of the integration of the medical apparatus into the patient network.

6. The method as claimed in claim 1, further comprising communicating information regarding which apparatuses are integrated in the patient network from an information center to the medical apparatus.

7. A wireless medical apparatus having a transceiver unit, an indicating device and an input device and having a means for automatic integration of the medical apparatus into a patient network.

8. (canceled)

9. The wireless medical apparatus as claimed in claim 7 having a transceiver unit that permits communication in different networks.

10. The wireless medical apparatus as claimed in claim 7, wherein the means for automatic integration includes an input by clinic personnel.

11. The wireless medical apparatus as claimed in claim 7 having a display and having a search function for finding medical apparatuses of a specific type or a specific medical apparatus; and wherein the search result is shown on the display.

12. (canceled)

13. (canceled)

14. A medical apparatus comprising:
means for detecting a current location of the medical apparatus;
means for locating a closest patient network when the medical apparatus is in the same current location for a predetermined time period; and
means for integrating the medical apparatus into the located closest patient network.

15. The medical apparatus of claim 14 wherein the means for integrating the medical apparatus into the located closest patient network includes means for entering an input to enable integration.

16. The medical apparatus of claim 14 further comprising means for associating a patient name with the medical apparatus.

17. The medical apparatus of claim 16 wherein the means for associating a patient name with the medical apparatus includes means for selecting the patient name from a patient name list.

18. The medical apparatus of claim 16 wherein the means for associating a patient name with the medical apparatus includes determining the patient name from a portable locatable unit provided to the patient.

19. The medical apparatus of claim 18 wherein the portable locatable unit is wearable.

20. The medical apparatus of claim 14 wherein the medical apparatus is automatically integrated into the closest patient network after a predetermined time interval commencing once the closest patient network has been located.

21. The medical apparatus of claim 14 further comprising means for detecting other medical apparatuses located within a predetermined distance of the medical apparatus.

22. The medical apparatus of claim 21 wherein the location of other medical apparatuses is used, at least in part, to provide the current location of the medical apparatus.
